(19) United States
(12) Patent Application Publication
(10) Pub. No.: US 2005/0151975 A1
(43) Pub. Date: Jul. 14, 2005

(54) Fabry-perot fiber optic sensing device and method

(76) Inventor: Ivan Melnyk, Coquitlam (CA)

Correspondence Address: lvan Melnyk, 604 Cottonwood Ave, Coquitlam, BC, V3J2S4, CA

(21) Appl. No.: 10/756,329

(22) Filed: Jan. 14, 2004

(51) Int. Cl. G01B 9/02

(52) U.S. Cl. 356/480

(57) ABSTRACT

The invention provides a device and a method for measuring a physical parameter. The device comprises a Fabry-Perot interferometer coupled to a polychromatic light source via fiber optic means. Light, modulated by the Fabry-Perot cavity, is recorded by a spectrometer. A phase function is calculated by a signal processing means from the modulated spectrum. Correlation coefficients are calculated between the determined phase function and a number of theoretical phase functions calculated for a variety of gap spacing of the Fabry-Perot cavity or a number of calibrated phase functions measured for variety of values of physical parameter. The gap spacing, which is associated with the physical parameter, is determined from the best-matched phase function. The processing time is shortened by the approximate estimation of the gap spacing through the position of the maximums and minimums of the modulated spectrum and by consequent precise determining of the gap spacing through correlation.

### TECHNICAL FIELD

The present invention relates to fiber optic sensing technology, and more specifically to a sensor and method using a Fabry-Perot optical interferometer and spectral signal demodulation for measurement of a physical parameter such as a pressure, a temperature, a strain, and a refractive index with a high accuracy and within a large range of physical parameters.

### BACKGROUND

Fiber optic Fabry-Perot sensing technology allows to achieve high accuracy and resolution. The technology is based on measurement of the gap spacing of the Fabry-Perot cavity that is changed with the physical parameter. For example, the gap spacing is changed when an external pressure is applied to the cavity or temperature expands the gap spacing due to the thermal expansion of the materials. Optical path inside the cavity, which represents a product of the gap spacing and refractive index, is changed with refractive index of the media inside the cavity. This feature may be used for accurate measurement of the refractive index. A fiber optic Fabry-Perot interferometer consists of a sensing Fabry-Perot cavity coupled to an optical fiber, an opto-electronic unit with a light source, a demodulator and a signal processing means. Fiber optic means connect the light source to a Fabry-Perot cavity which is remotely located in the measuring zone. Light from the light source is modulated in the cavity and it is returned back to the opto-electronic unit either through the same or through another optical fiber depending on whether single or double fiber design is used. The light is modulated accordingly with the gap spacing or optical path. The incoming light is demodulated by means of counting the light pulses passing trough the detector (monochromatic interferometry) or by analyzing the distribution of interferometric fringes over the wide optical spectrum (white-light interferometry). White-light interferometry utilizing Fabry-Perot cavities is particularly suitable for field applications because polychromatic light sources have smaller temperature drift than monochromatic light sources (lasers). Also, white-light interferometry provides an absolute measurement of the gap spacing as oppose to a relative measurement, which is achieved in monochromatic interferometry by counting the number of pulses.

Known in the art is a solution in which the light from the Fabry-Perot cavity is demodulated by using a Fizeau interferometer as is described by U.S. Pat. No. 5,392,117, BELLEVILLE, Feb. 21, 1995. The wedge structure of the Fizeau interferometer allows to perform a simple algorithm for the correlation analysis of the modulated light. The position of the maximum of the cross-correlation coefficients coincides with the length of the gap spacing. Although simple and robust, this method has disadvantage of providing the low signal-to-noise ratio, SNR, which reduces the accuracy of the device. As is shown in the document CHEN et al., “Fringe order identification in electronically-scanned optical fibre white-light interferometry: a novel method”, 8^{th} OFS Conf, IEEE, 1991, the modulated light is strongly distorted in the wedge interferometer by noise and non-uniformity of the position sensitive detector (see an example of the recorded signal in FIG. 1). Also, low SNR limits the distance at which measurement can be taken due to the light attenuation in optical fiber. The SNR could be improved by multiple averaging, however, this will increase the processing time which consequently slows the sensing device.

It is also known in the art a fiber optic Fabry-Perot temperature sensor which is based on comparison of the modulated spectrum with reference spectra corresponding to a plurality of calibrated temperatures (see U.S. Pat. No. 6,141,098, SAWATARI et al., Oct. 31, 2000). The comparison is provided by calculation of the difference between the measured spectrum and a plurality of reference spectra; the minimum absolute distance between those compared spectra will indicate the real value of the measured temperature. The normalized modulated light is calculated by subtracting the reference spectrum from the actual measured spectrum and dividing it by the average intensity of the reference spectrum. Such algorithm, however, does not take into account that the real spectrum is affected by noise from the position sensitive detector (CCD or CMOS array) of the optical spectrometer. In particular, for a low finesse Fabry-Perot cavity, such as one described in the cited document (a cavity having reflective surfaces of 4% reflection), provides the low modulation depth of the light. This makes impossible to select the proper calibrated temperature because noise contributes substantially to the actual recorded spectrum. Also, the normalized spectrum has a fluctuated average value, which is shown as a dotted line in FIG. 2. If the average value is changed, the contribution from the different fringes of the modulated spectrum is not equal in the total absolute distance between the reference and measured spectra. For example, the contribution from the first fringe shown in FIG. 2 will be smaller than that of fifth fringe because the latter has higher amplitude. Such an inadequate contribution reduces the accuracy of the device because the closest calibrated spectrum cannot not be exactly determined. The inaccurate determination of the best-matched spectrum becomes more significant for large changes of the gap spacing due to the changes of the number of fringes. This reduces the measuring range of the physical parameter.

Therefore, there is a need for a Fabry-Perot device and method based on white-light interferometry, which will provide accurate measurements over wide range of measuring parameter and which be capable of measuring physical parameter at long distance.

### SUMMARY OF INVENTION

An object of the present invention is to provide a fiber optic Fabry-Perot sensor utilizing white-light interferometry, which is accurate and precise over wide range of measuring parameter.

It is further object of the invention to provide such a fiber optic sensor with capability of measuring physical parameter at long distance.

Still another object of the invention is to provide such a fiber optic sensor, which will be applicable for fast measurement of physical parameter.

According to the present invention, a phase function of the sensing Fabry-Perot cavity is determined by registering the modulated spectrum with a microspectrometer. Correlation coefficients between the measured phase function and a plurality of reference phase functions are calculated by the signal processing means. The reference phase functions could be either theoretical, which are calculated for a plurality of gap spacing representing a plurality of values of measuring parameter, or experimental, which are taken for a plurality of calibrated measuring parameters and stored in the memory. The best-matched reference phase function is selected based on maximum correlation and correspondent value of the physical parameter is presented as measured value. Spectral decoding of the modulated light provides better signal-to-noise ratio than wedge interferometer. Also, correlation analysis provides better accuracy over wide range of measuring parameter than comparison of absolute distances between the measured spectrum and reference spectra.

The phase function is determined by normalizing the modulated spectrum between neighboring pairs of minimums and maximums in the following steps. The interpolated signal between two local minimums is subtracted from the actual spectrum within the same spectral range. The difference is multiplied by the coefficient which represents the portion between the interpolated maximums, interpolated minimums and the actual spectrum. The average value of such normalized spectrum is not changed over entire spectral range of the polychromatic light source; therefore, the corresponded measured phase function is not distorted.

Since positions of maximums and minimums of the measured spectrum are known for purpose of normalization, the precise gap spacing is determined in two steps according to second embodiment of the present invention. First, the approximate gap spacing is calculated based on maximums and minimums of the modulated spectrum. Second step includes calculation of correlation coefficients between measured phase function and reference phase functions within the narrow range of gap spacing which is in proximity to the approximated gap spacing. This algorithm reduces the calculation time and allows to select the reference phase function faster rather than comparing the entire assembly of phase functions.

Still further shortening of the calculation time is achieved by tracking the position of the correlation maximum within at least three reference functions, from which one corresponds to currently determined gap spacing, and two others correspond to next smaller and larger gap spacing, respectively. This reduces the calculation to only three correlation coefficients as oppose to thousands of correlation coefficients calculated over entire measuring range of the device.

Other features and advantages of the present invention will become apparent from the following detailed description of possible embodiments made in reference to the appended drawings.

### BRIEF DESCRIPTION OF DRAWINGS

FIG. 1 is an example of the modulated light recorded by a prior art, a wedge interferometer.

FIG. 2 is an example of the normalized modulated spectrum recorded according to the second prior art.

FIG. 3A is an example of the modulated spectrum measured by the spectrometer and been used for normalization according to the present invention.

FIG. 3B is a measured phase function which corresponds to measured modulated spectrum of FIG. 3A.

FIG. 4 is a schematic view of a fiber optic sensing device for measuring a physical parameter according to the present invention.

FIG. 5 is an example of two spectra recorded from a sensing Fabry-Perot interferometer using a setup of FIG. 4 for two values of measuring parameters, pressures P=0 (solid line) and P=300 psi (dashed line); short fiber optic cable, SNR=500.

FIG. 6 are graphs of correlation coefficients calculated for two values of physical parameters of FIG. 5.

FIG. 7 are graphs of correlation coefficients of FIG. 6 presented in gap spacing scale.

FIG. 8 is a flow-chart of the second embodiment of the present invention, which provides faster determination of the gap spacing by calculating the estimated gap spacing using positions of the local maximums and minimums and precise determination of the gap spacing using the correlation method.

FIG. 9 illustrates the method for fast tracking of the position of the correlation maximum by comparing the correlation coefficients calculated for three phase functions only.

FIG. 10 represents the flow-chart of the tracking algorithm of FIG. 9.

FIG. 11 is an example of the spectrum recorded from a sensing Fabry-Perot interferometer using a setup of FIG. 4, measuring pressure P=0, long optical cable (L=1 km), SNR=5.

FIG. 12 are graphs of correlation coefficients calculated at P=0 for long (spectrum of FIG. 10, SNR=5) and short (spectrum of FIG. 5, solid line, SNR=500) fiber optic cables.

### DESCRIPTION

Throughout the following description, specific details are set forth in order to provide a more thorough understanding of the invention. However, the invention may be practiced without these particulars. In other instances, well known elements have not been shown or described in detail to avoid unnecessary obscuring the invention. Accordingly, the specification and drawings are to regarded in an illustrative, rather than a restrictive, sense.

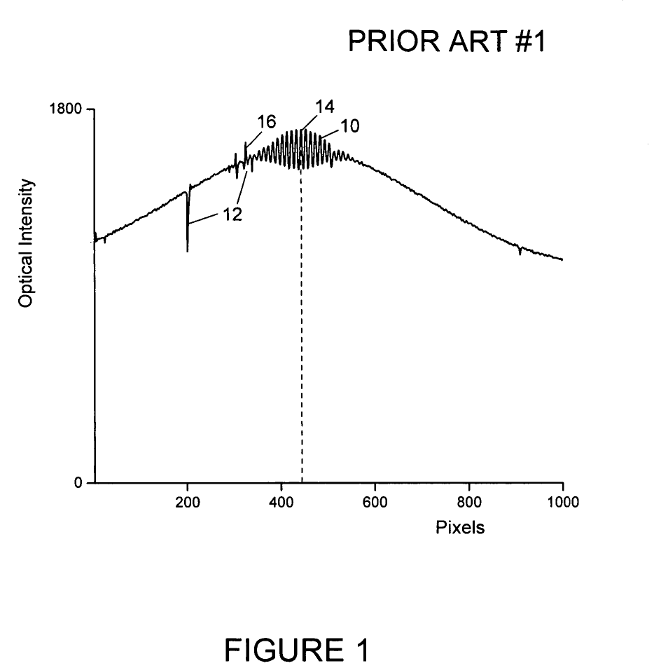

FIG. 1 shows a light distribution at a position sensitive detector coming from a Fabry-Perot cavity with the reference to the first prior art, a wedge interferometer, as is described by CHEN et al., “Fringe order identification in electronically-scanned optical fibre white-light interferometry: a novel method”, 8^{th} OFS Conf, IEEE, 1991. The picture clearly indicates a low portion of the modulated light (10), in the entire level of the optical intensity. Also, the incoming light has a substantial portion of noise (12). It could be shown that the recorded light distribution is related to cross-correlation coefficients calculated from thinner to thicker portion of the wedge. The position of the maximum (14) of the signal represents the correlation maximum and it corresponds to the actual gap spacing. In FIG. 1, for example, the maximum approximately corresponds to pixel #420. The maximum shifts along the pixel scale accordingly with the gap spacing, smaller gap spacing shifts the maximum toward thinner side of the edge and vice versa. Low level of the modulated signal creates a risk of mistakenly detected maximum which could be far away from the real location. For example, a peak (16) could have higher level than the expected maximum (14).

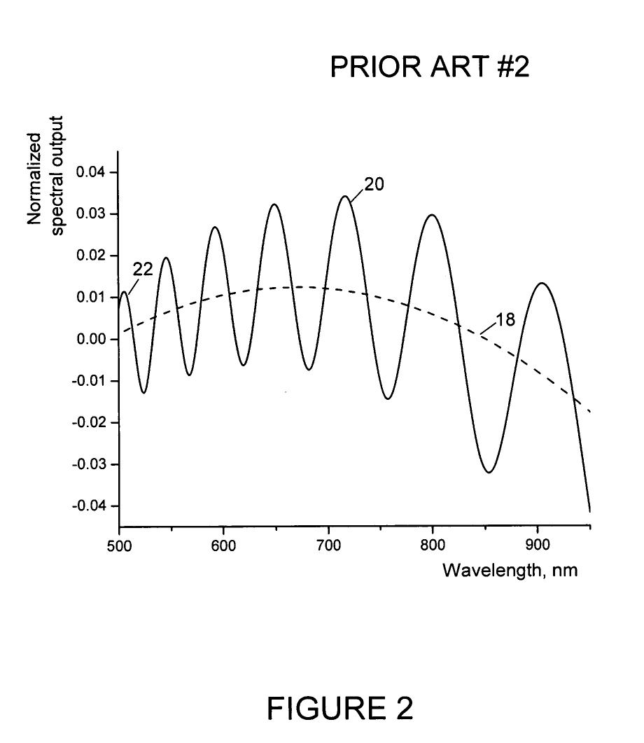

FIG. 2 describes the normalized spectrum of the incoming light from the Fabry-Perot cavity with a reference to U.S. Pat. No. 6,141,098, SAWATARI et al., Oct. 31, 2000. The polychromatic light is extended from 500 to 950 nm and it includes several peaks which correspond to maximums of the interferometric pattern. The average value of the signal, a dotted line (18), is changed with wavelengths. Such a normalized spectrum must be compared with the plurality of calibrated spectra stored in the memory of the signal processing means by subtracting the actual data from the stored data at each wavelength and calculating the total absolute difference or distance. This distance is supposed to be equal zero if the calibrated data exactly matches the measured spectrum. However, the real spectrum has noise which is omitted in FIG. 2. Noise introduces an uncertainty to the total calculated distance which makes the exact match impossible. Also, the change of gap spacing causes the redistribution of the light intensity between fringes. This is observed as fringe shifting along the wavelength axis. The shift changes the total absolute distance caused not only by gap spacing, but inadequate contribution from different fringes too. For example, the fifth maximum (20) contributes more to the total distance than the first maximum (22), which intensity is approximately three times lower. Therefore, if the peak (20) approaches the dotted line (18), the average contribution from this fringe is minimum while another fringe will be dominant in the spectrum. The latter unbalances the total absolute distance, which leads to an inaccurate determination of the best matched reference value.

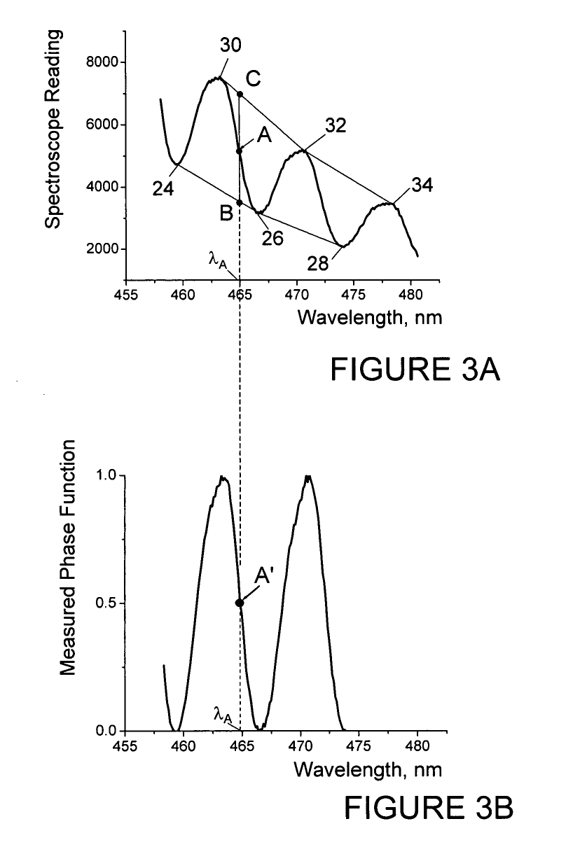

According to the present invention, a phase function of the sensing Fabry-Perot cavity is determined by registering the modulated spectrum with a microspectrometer. A portion of the modulated spectrum is shown in FIG. 3A. The spectrum was recorded by a fiber optic spectrometer (NA=0.1; slit 10 μm; diffractive grating 1200 lines/mm; 2048 pixel linear CCD array) coupled to the Fabry-Perot cavity with 30% reflective surfaces; the cavity was illuminated by a white light emitting diode (LED) using a 200 μm fiber. The signal processing means, which is preferably a digital signal processor (DSP) determines positions of the local minimums and maximums of the spectra. FIG. 3A presents three minimums and three maximums, points (24), (26), (28) and points (30), (32), (34), respectively. The value of the measured phase function in the arbitrary point A′ at the wavelength λ_{A} shown in FIG. 3B is determined from the measured spectrum in the following way:

The value of the measured spectrum U_{A} at the same wavelength λ_{A} (point A in FIG. 3A) is reduced by the interpolated minimum value U_{B} which is presented as point B in FIG. 3A. This value is calculated from spectroscope readings at two local minimums (24) and (26) between which wavelength λ_{A} is located. The calculation can be done by using a variety of techniques, such as linear interpolation shown in FIG. 3A, polynomial approximation, etc. The difference (U_{A}-U_{B}) is divided by (U_{C}-U_{B}), where U_{C} is the interpolated maximum value which is presented as point C in FIG. 3A. The location of point C is determined from two local maximums (30) and (32) using the same interpolation technique as for point B.

As is seen from FIG. 3B, the phase function, determined in such a way, is free from fluctuation of average value even though positions of local maximums and minimums are not exactly defined due to the presence of noise. The maximum value of the measured phase function equals 1.0. This value could be adjusted to an exact theoretical value determined for an ideal reflective Fabry-Perot cavity by equation:

$$I ( d , λ , n ) = \frac{F {sin}^{2} ( \frac{2 π d n}{λ} )}{1 + F {sin}^{2} ( \frac{2 π d n}{λ} )} , \qquad ( 1 )$$

where d is the gap spacing, n is the refractive index of the medium inside the cavity. The half-width of the fringes, F, is determined by the reflection coefficient R of the mirrors which represent the Fabry-Perot cavity as

$$F = \frac{4 R}{{( 1 - R )}^{2}} \qquad ( 2 )$$

At R=0.3, the maximum value of the function

$$I = {I}_{max} = \frac{F}{1 + F}$$

is 0.74.

Calculated value at every point at FIG. 3B has to be corrected by factor 0.74 in order to get the exact value of phase function for R=0.3.

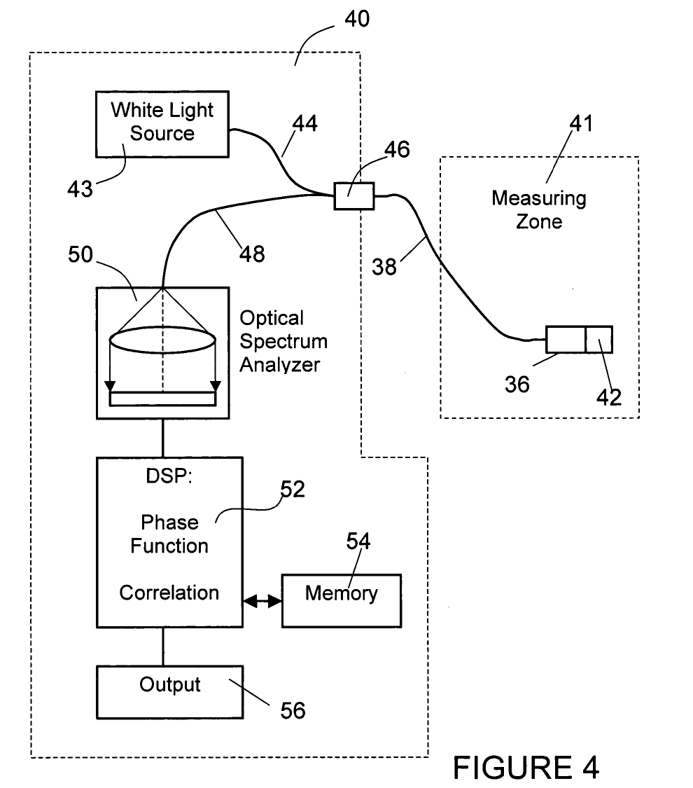

The preferred embodiment of the device according to the present invention is explained in FIG. 4. The device consists of a Fabry-Perot sensing interferometer (36) coupled with a fiber optic cable (38) to an opto-electronic unit (40). The Fabry-Perot sensing interferometer is located in a measuring zone (41); its gap spacing or optical path (42) is changed with the physical parameter. The opto-electronic unit consists of a white light source (43), which generates a broad-band (polychromatic) light and illuminates the sensing interferometer (36) through an illuminating fiber (44). The fiber (44) may be coupled to the fiber optic cable (38) through a coupler (46), which another arm, a receiving fiber (48), is coupled to an optical spectrum analyzer (50). The white light source is preferably a single light emitting diode (LED) with a typical spectral width of 50 nm, or a combination of LEDs that produces broader spectral width. Spectral width of white LEDs could be up to 200 nm. This is close to the spectral width of miniature incandescent bulbs that can be used in the device though their lifetime is shorter than LEDs. Preferably, the spectral range of the light source is extended over visible and near-infrared region where silicon-based photodetectors can be effectively used (wavelengths from 0.4 to 1.1 μm). However, longer wavelengths, such as those used in fiber optic communication systems (1.3, 1.5 and 1.6 μm windows) can be utilized in order to achieve long connection between the measuring zone and the opto-electronic unit. The optical spectrum analyzer (50), represents a microspectrometer with a position sensitive photodetector, preferably a linear CCD or CMOS detector array. The spectrometer registers the receiving light over the whole optical spectrum generated by the polychromatic light source. Preferably, the spectrometer is based on a diffractive grating. This design allows to build compact spectrometers with the optical resolution of a fraction of a nanometer. Alternatively, the spectrometer can be built using a linear variable filter, such as made by Optical Coating Laboratory Inc., California. Such a filter has a multi-layer interference coating which selectively transmits the light along the filter without dispersing it angularly.

Spectrum from the optical spectrometer is processed in a signal processing means (52), which is preferably based on a digital signal processor (DSP) or a microcontroller. DSP calculates the measured phase function in a way as was described in FIG. 3A and FIG. 3B and calculates a number of correlation coefficients between the measured phase function and a plurality of reference phase functions. Reference phase function can be either calculated using equations (1) and (2) for a plurality of gap spacing or they can be measured at calibrated conditions for the various values of physical parameters. The range of possible gap spacing and calibrated values of physical parameters are defined by the desirable operating range of the device. Calculated and calibrated phase functions are preferably stored in a memory (54) associated with DSP. DSP calculates correlation coefficients for all reference phase functions or for limited number of phase functions as it is described below. The maximum correlation means the best match between the measured phase function and a selected reference phase function. The result of correlation analysis, either the selected gap spacing, which adequately corresponds to the measured physical parameter, or selected calibrated value of the physical parameter, is used by an output circuit (56) for communication with associated industrial control systems or for indication.

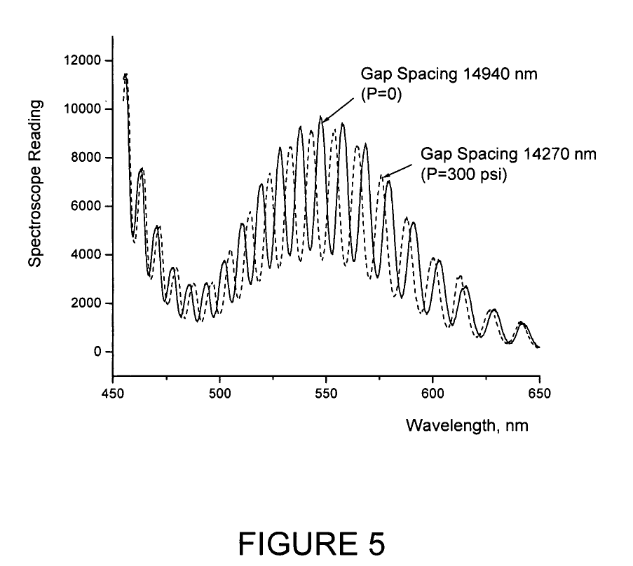

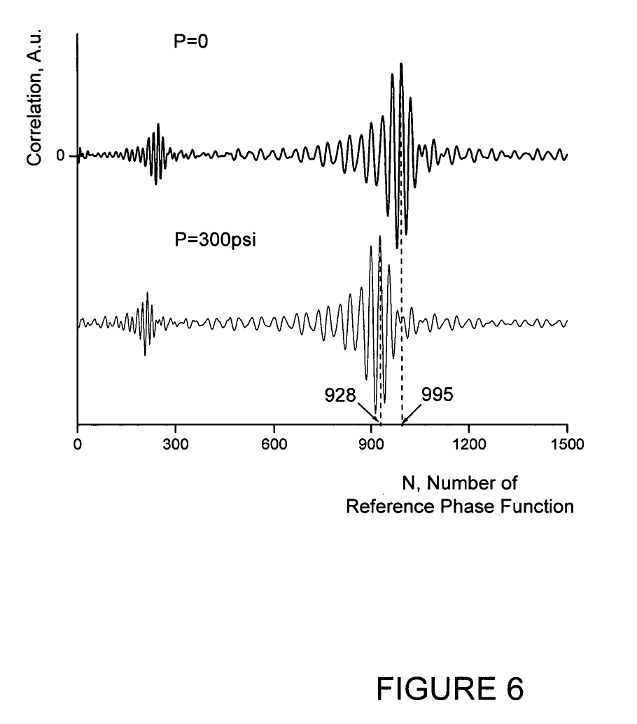

Referring to FIG. 5, an example of two spectra recorded by the microspectrometer at two values of physical parameter is shown. The light source is a white LED generating light from 450 to 650 nm, the Fabry-Perot cavity has both reflective surfaces of the same reflection, R=30%. The solid line corresponds to zero measured pressure (P=0, gap spacing d=14940 nm), and the dashed line corresponds to pressure of P=300 psi, gap spacing d=14270 nm. Signal-to-noise ratio for this example is 500. FIG. 6 shows the corresponded graphs of correlation coefficients calculated for 1500 reference phase functions (the bottom graph was shifted from its zero average value for purpose of comparison). Reference phase functions were calculated for gap spacing from 5000 to 20000 nm with the step of 10 nm. Each graph indicates a sharp peak of the correlation maximum. At initial value of physical parameter (P=0), the maximum correlation is achieved for 995^{th} phase function (N=995), while at the measured value of P=300 psi, the maximum correlation occurred at N=928. Number of phase function, N, is directly associated with the absolute value of gap spacing as:
d=d₀+(N−1)S (3)
where d₀ is the minimum gap spacing, and S is the spacing step.

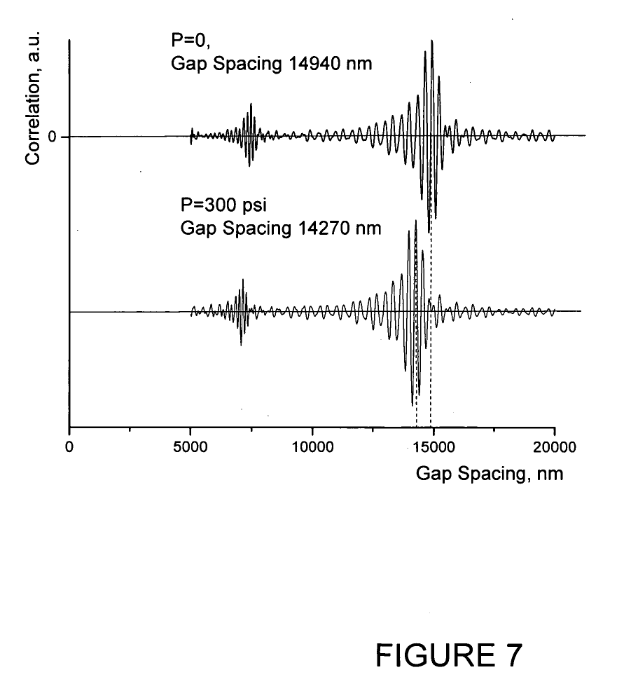

FIG. 7 shows the same graphs using the gap spacing scale for d₀=5000 nm and S=10 nm. Sharp peak of the correlation maximum indicates that gap spacing can be determined with a high accuracy. In the given example, the resolution from the direct readout is limited by one step S. The resolution can be improved by increasing the number of reference phase functions, which is equivalent to reducing the step S, and by precise determination of the maximum location which could be done by using any known procedures, such as calculating the shape of the correlation maximum, etc.

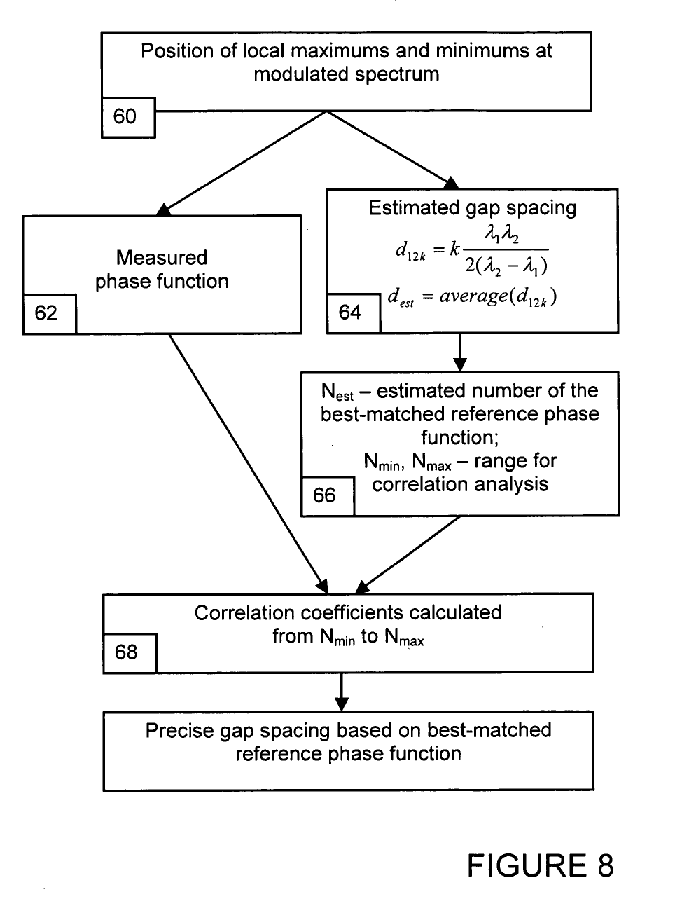

According to another embodiment of the present invention, the processing time can be shortened while still using the small spacing step dS if the algorithm described in FIG. 8 is used. The measured function is determined from the modulated spectrum following the steps (60) and (62) in the same way as it was described earlier and explained in FIG. 3A and FIG. 3B. Positions of local maximums and local minimums on the measured spectrum are used for calculation of the estimated gap spacing (64). If λ₁ and λ₂ are coordinates of either maximums or minimums of the measured spectrum (and, correspondently, measured phase function), between which k fringes ale located, the gap spacing can be calculated as

$${d}_{12 k} = k \frac{{λ}_{1} {λ}_{2}}{2 ( {λ}_{2} - {λ}_{1} )} \qquad ( 4 )$$

Preferably, the estimated gap spacing dₑₛₜ is determined as mean value of d₁₂ₖ calculated for all minimums and maximums in order to narrow the search for precise gap spacing using correlation analysis
dₑₛₜ=average(d₁₂ₖ) (5)

During the step (66), an estimated number of the best-matched reference phase function Nₑₛₜ is followed from the value of dₑₛₜ. A more accurate determination is done within the range of numbers from Nₘᵢₙ and Nₘₐₓ which are defined as:
Nₘᵢₙ=Nₑₛₜ−ΔN
Nₘₐₓ=Nₑₛₜ+ΔN (6)
where ΔN is the maximum possible deviation of the estimated value Nₑₛₜ from the accurate value N. This deviation is defined by how dₑₛₜ is close to the real gap spacing. In practice, a similar zero-crossing approach of determining d provides the accuracy better than 1%. This reduces the number ΔN to less than 0.01 of Nₑₛₜ. At step (68), DSP calculates correlation coefficients for the total number of reference phase functions
2ΔN=Nₘₐₓ−Nₘᵢₙ, (7)
within which the precise value N is determined based on maximum correlation value. The value 2 ΔN is only a fraction of a total number of reference phase functions. This substantially reduces the number of correlation calculations and, consequently, the processing time.

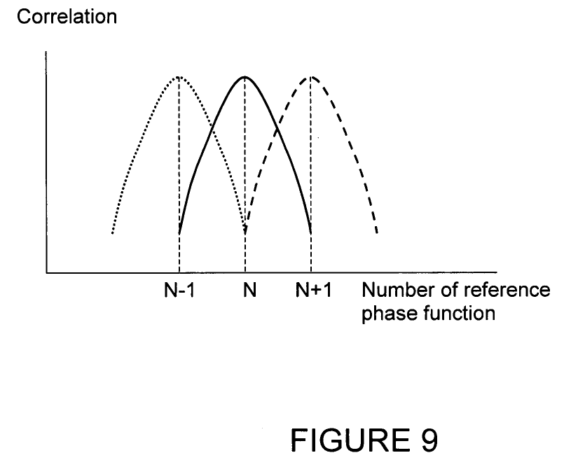

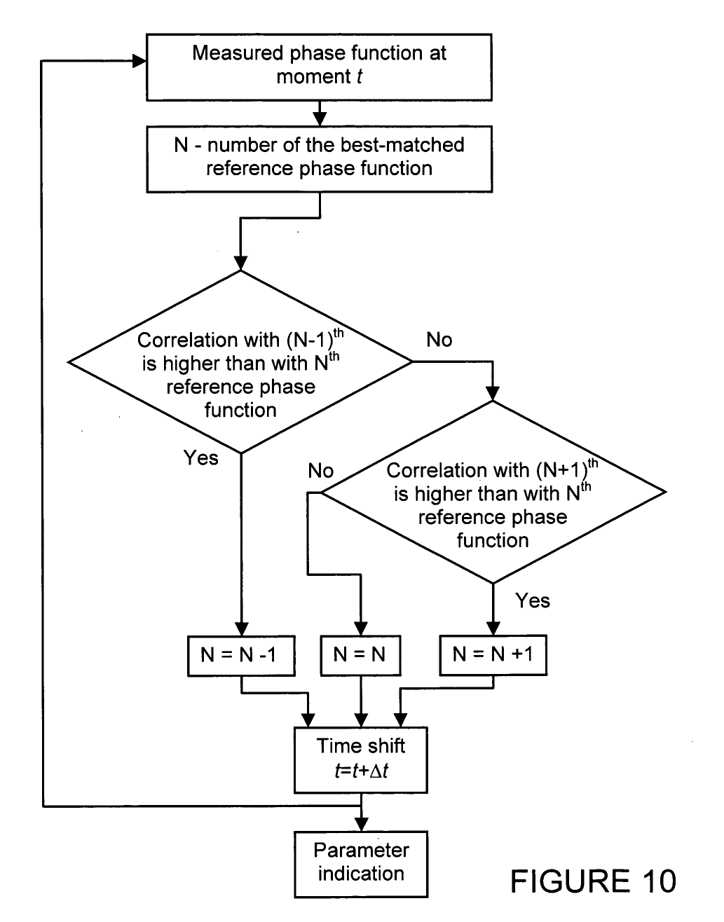

Correlation method of signal processing according the present invention allows further improvement of processing speed by tracking the position of the correlation maximum. It is explained in FIG. 9 and flow-chart of the algorithm is shown in FIG. 10. If N^{th} phase function provides the best correlation at given time, correlations for (N−1)^{th} and (N+1)^{th} reference phase functions are calculated and compared at the next moment. Either one, N−1, N, or N+1 reference phase function is selected based on criteria of maximum correlation. The procedure is repeated in the next moment which is defined by the refresh rate of signal processing. The advantage of such an algorithm is that only two correlation coefficients have to be calculated for accurate determining the shift of the measuring parameter.

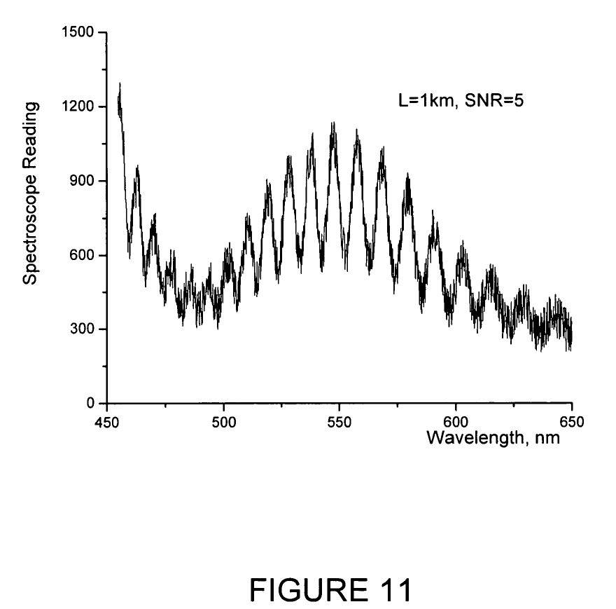

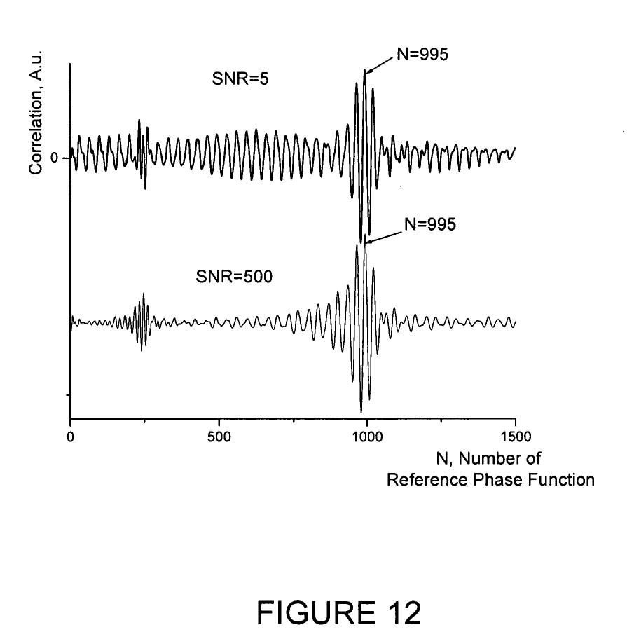

SNR is reduced with the length of the cable because of the light attenuation in optical fibers. FIG. 11 represents a spectrum recorded from a fiber optic pressure sensor at fiber length of 1 km. The measured pressure value was set at P=0, which corresponds to gap spacing of 14940 nm. The spectrum is highly distorted by the noise because of the high light losses. The effective SNR is reduced from 500 (short cable, L=1 m, spectrum is shown in FIG. 5) to 5.0 for distance of 1 km. This, however, does not change the position of the correlation maximum according to the present invention. FIG. 12 shows the comparison between correlation coefficients calculated for a noisy signal, SNR=5, and for a signal with low noise level, SNR=500. The maximum correlation peak has not been shifted from its position at N=995. This indicates that correlation method of signal processing described above determines the exact value of the physical parameter for long distances.

Although the present invention has been described by way of examples thereof, it should be pointed out that any modifications to these examples, within the scope of the appended claims, are not deemed to change or alter the nature and scope of the present invention.

1. A fiber optic sensing method for measuring a physical parameter, comprising steps of:
(a) illuminating a Fabry-Perot cavity with a polychromatic light using a fiber optic means;
(b) determining a phase function of said cavity by measuring the spectrum of said polychromatic light with an optical spectrometer means;
(c) determining the value of the physical parameter by calculating a correlation between said determined phase function and theoretical phase functions, calculated for a plurality of physical parameters.

2. A fiber optic sensing method for measuring a physical parameter according to claim 1 further comprising steps of:
(a) an estimation of the gap spacing of said cavity based on said determined phase function;
(b) calculating a set of theoretical phase functions associated with a plurality of gap spacing, which is in proximity to said estimated gap spacing;
(c) determining a precise gap spacing by calculating a correlation between said determined phase function and said set of theoretical phase functions;
(d) assigning the value of the physical parameter based on said determined precise gap spacing.

3. A fiber optic sensing method for measuring a physical parameter according to claim 2 wherein said estimation of the gap spacing of said cavity is based on determination of the positions of maximums and minimums of said determined phase function;

4. A fiber optic sensing method for measuring a physical parameter according to claim 2 further comprising steps of:
(a) calculating at least three theoretical phase functions, from which one is corresponded to said precise gap spacing at given time, one is corresponded to a smaller gap spacing and one is corresponded to a larger gap spacing;
(b) calculating correlation between said determined phase function and said at least three theoretical functions;
(c) assigning a new value of the precise gap spacing at the next time to one of said at least three gap spacing based on said calculated correlation.

5. A fiber optic sensing method for measuring a physical parameter according to claim 1 wherein said step of determining a phase function of said cavity by measuring the spectrum of said polychromatic light with an optical spectrometer means further includes steps of:
(a) determining an interpolated minimum value for each wavelength between two adjacent minimums of the measured modulated spectrum;
(b) determining an interpolated maximum value for each wavelength between two adjacent maximums of the measured modulated spectrum;
(c) a first subtraction, subtracting the measured value at from said maximum value at corresponded wavelength;
(d) a second subtraction, subtracting said minimum value at from said measured value at corresponded wavelength;
(e) dividing the result of said first subtraction by the result of said second subtraction.

6. A fiber optic sensing method for measuring a physical parameter, comprising steps of:
(a) illuminating a Fabry-Perot cavity with a polychromatic light using a fiber optic means;
(b) determining a phase function of said cavity by measuring the spectrum of said polychromatic light with an optical spectrometer means;
(c) determining the value of the physical parameter by calculating a correlation between said determined phase function and calibrated phase functions, recorded for a plurality of physical parameters.

7. A fiber optic sensing method for measuring a physical parameter according to claim 6 further comprising steps of:
(a) an estimation of the gap spacing of said cavity based on said determined phase function;
(b) restoring a set of recorded phase functions associated with a plurality of gap spacing, which is in proximity to said estimated gap spacing;
(c) determined a precise gap spacing by calculating a correlation between said determined phase function and said set of recorded phase functions;
(d) assigning the value of the physical parameter based on said determined precise gap spacing.

8. A fiber optic sensing method for measuring a physical parameter according to claim 7 wherein said estimation of the gap spacing of said cavity is based on determination of positions of maximums and minimums of said determined phase function;

9. A fiber optic sensing method for measuring a physical parameter according to claim 7 further comprising steps of:
(a) restoring at least three recorded phase functions, from which one is corresponded to said precise gap spacing at given time, one is corresponded to a smaller gap spacing and one is corresponded to a larger gap spacing;
(b) calculating correlation between said determined phase function and said at least three recorded functions;
(c) assigning a new value of the precise gap spacing at the next time to one of said at least three gap spacing based on said calculated correlation.

10. A fiber optic sensing device for measuring a physical parameter comprising:
(a) a polychromatic light source, coupled by a fiber optic means to a Fabry-Perot cavity, which gap spacing is changed with physical parameter;
(b) an optical spectrometer means for determining a phase function of said Fabry-Perot cavity by registering a spectrum of said polychromatic modulated by said cavity;
(c) a signal processing means for determining the value of the physical parameter by calculating a correlation between said determined phase function and theoretical phase functions, calculated for a plurality of physical parameters.

11. A fiber optic sensing device for measuring a physical parameter according to claim 10 wherein said signal processing means:
(a) determines the estimated value of the gap spacing of said cavity based on said measured phase function;
(b) calculates a set of theoretical phase functions associated with a plurality of gap spacing, which is in proximity to said estimated gap spacing;
(c) determined a precise gap spacing by calculating a correlation between said measured phase function and said set of theoretical phase functions;
(d) assigns the value of the physical parameter based on said determined precise gap spacing.

12. A fiber optic sensing device for measuring a physical parameter according to claim 11 wherein said estimation of the gap spacing is provided by determination of positions of maximums and minimums of said determined phase function;

13. A fiber optic sensing device for measuring a physical parameter according to claim 11 wherein said signal processing means:
(a) calculates at least three theoretical phase functions, from which one is corresponded to said precise gap spacing at given time, one is corresponded to a smaller gap spacing and one is corresponded to a larger gap spacing;
(b) calculates correlation between said determined phase function and said at least three theoretical functions;
(c) assigns a new value of the precise gap spacing at the next time to one of said at least three gap spacing based on said calculated correlation.

14. A fiber optic sensing device for measuring a physical parameter comprising:
(a) a polychromatic light source, coupled by a fiber optic means to a Fabry-Perot cavity, which gap spacing is changed with physical parameter;
(b) an optical spectrometer means for determining a phase function of said Fabry-Perot cavity by registering a spectrum of said polychromatic modulated by said cavity;
(c) a signal processing means for determining the value of the physical parameter by calculating a correlation between said measured phase function and calibrated phase functions, recorded for a plurality of physical parameters.

15. A fiber optic sensing device for measuring a physical parameter according to claim 14 wherein said signal processing means:
(a) determines the estimated value of the gap spacing of said cavity based on said determined phase function;
(b) restores from the memory a set of recorded phase functions associated with a plurality of gap spacing, which is in proximity to said estimated gap spacing;
(c) determined a precise gap spacing by calculating a correlation between said measured phase function and said set of recorded calibrated phase functions;
(d) assigns the value of the physical parameter based on said determined precise gap spacing.

16. A fiber optic sensing device for measuring a physical parameter according to claim 14 wherein said estimation of the gap spacing is provided by determination of positions of maximums and minimums of said determined phase function;

17. A fiber optic sensing device for measuring a physical parameter according to claim 14, wherein said signal processing means:
(a) restores from the memory at least three recorded calibrated phase functions, from which one is corresponded to said precise gap spacing at given time, one is corresponded to a smaller gap spacing and one is corresponded to a larger gap spacing;
(b) calculates correlation between said measured phase function and said at least three recorded functions;
(c) assigns a new value of the precise gap spacing at the next time to one of said at least three gap spacing based on said calculated correlation.
